(19) United States
(12) Patent Application Publication
(10) Pub. No.: US 2018/0169517 A1
(43) Pub. Date: Jun. 21, 2018

(54) REACTIVE ANIMATION FOR VIRTUAL REALITY

(71) Applicant: THOMSON LICENSING, Issy-Les-Moulineaux (FR)

(72) Inventor: Adam BALEST, West Hollywood, CA (US)

(21) Appl. No.: 15/577,559

(22) PCT Filed: Sep. 14, 2015
(86) PCT No.: PCT/US2015/049897

§ 371 Date: Nov. 28, 2017

Related U.S. Application Data
(60) Provisional application No. 62/169,137, filed on Jun. 1, 2015.

(51) Int. Cl. A63F 13/212; A63F 13/211; A63F 13/26; A63F 13/428; A63F 13/5255; G06T 13/80; G06T 15/20

(52) U.S. Cl. CPC A63F 13/212; A63F 13/211; A63F 13/26; A63F 2300/8082; A63F 13/5255; G06T 13/80; G06T 15/205; A63F 13/428

(57) ABSTRACT

An optical system and method is provided for a virtual reality head-mounted display. In one embodiment, the system comprises a housing for mounting on a users head and coupled with the display, the housing permitting viewing focus on the display and a sensor operatively coupled with said housing and configured to detect a first change in a position of said housing from a first position to a second position, and detect a second change in a position of said housing greater than said first change. The processor is coupled to the display and is configured to render a first animation for output on said display, pre-load a second animation upon the sensor detecting the first change in position, and render the second animation for output to the display based on the sensor detecting the second change in position.

### TECHNICAL FIELD

The present invention relates generally to Virtual reality and in particular to a reactive animation enhanced Virtual Reality

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

In recent years, Virtual Reality (VR) has become the subject of increased attention. This is because VR can be used practically in every field to perform various functions including test, entertain and teach. For example, engineers and architects can use VR in modeling and testing of new designs. Doctors can use VR to practice and perfect difficult operations ahead of time and military experts can develop strategies by simulating battlefield operations. VR is also used extensively in the gaming and entertainment industries to provide interactive experiences and enhance audience enjoyment. VR enables the creation of a simulated environment that feels real and can accurately duplicate real life experiences in real or imaginary worlds. Furthermore, VR covers remote communication environments which provide virtual presence of users with the concepts of telepresence and telexistence or virtual artifact (VA).

Most virtual reality systems employ sophisticated computers that can engage with and become in processing communication with other multisensory input and output devices to create an interactive virtual world. In order to accurately simulate human interaction with a virtual environment, VR systems aim to facilitate input and output of information representing human senses. These sophisticated computing systems are then paired with immersive multimedia devices, such as stereoscopic displays and other devices to recreate such sensory experiences, which can include virtual taste, sight, smell, sound and touch. In many situations, however, among all the human senses, sight is perhaps most useful as an evaluative tool. Accordingly, an optical system for visualization is an important part of most virtual reality systems.

### SUMMARY

An optical system and method are provided for a virtual reality head-mounted display. In one embodiment, the system comprises a housing for mounting on a user's head and coupled with the display, the housing permitting viewing focus on the display and a sensor operatively coupled with said housing and configured to detect a first change in a position of said housing from a first position to a second position, and detect a second change in a position of said housing greater than said first change. The processor is coupled to the display and is configured to render a first animation for output on said display, pre-load a second animation upon the sensor detecting the first change in position, and render the second animation for output to the display based on the sensor detecting the second change in position.

In another embodiment, the method provides a virtual reality experience to a user via a head-mounted housing, comprising rendering, using a processor, an image for viewing by a user via the housing, the housing being coupled with a display. The method also comprises detecting, using the processor, a first change in a position of said housing, and detecting, using the processor, a second change in a position of said housing defining a change greater than said first change and rendering, using the processor, a first animation for output to said display. The second animation is then pre-loaded to a computing system comprising the processor in a state of the processor detecting said first change in position and the second animation is rendered using the processor, for output to said display in a state of the processor detecting said second change in position

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The invention will be better understood and illustrated by means of the following embodiment and execution examples, in no way limitative, with reference to the appended figures on which:

FIG. 1 depicts a user/player utilizing a VR head mounted optical system, configured for reactive animation according to one embodiment of the invention; and

FIG. 2 is a flow chart illustrating the method for operating the optical system such as the one used in the example of FIG. 1, according to one embodiment of the invention.

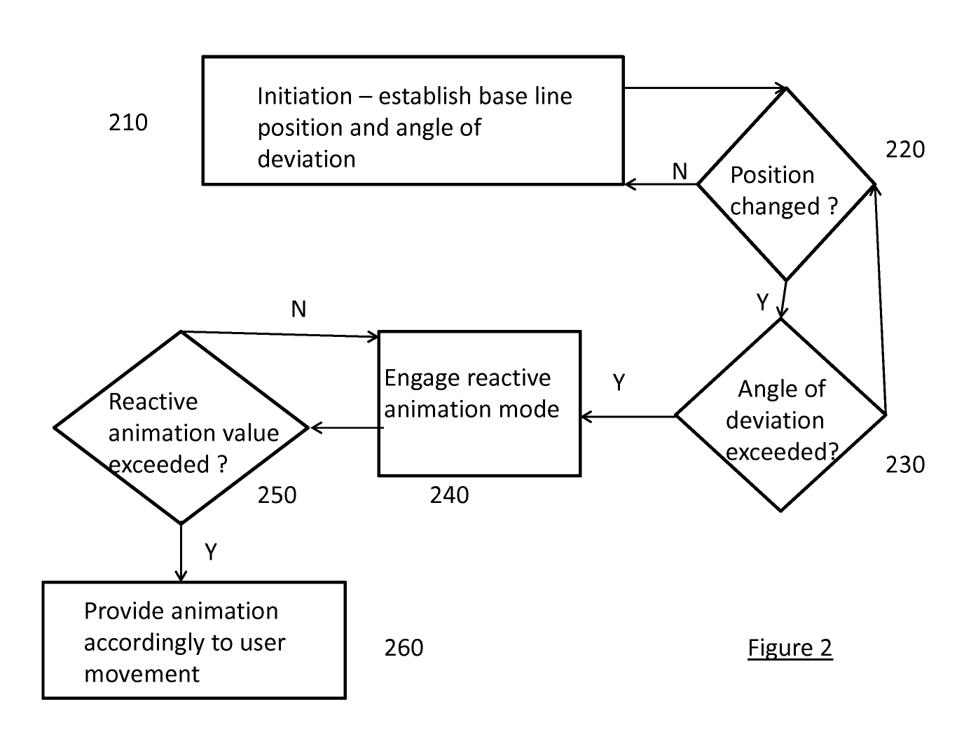

In FIG. 2, the represented blocks are purely functional entities, which do not necessarily correspond to physically separate entities. Namely, they could be developed in the form of software, hardware, or be implemented in one or several integrated circuits, comprising one or more processors.

Wherever possible, the same reference numerals will be used throughout the figures to refer to the same or like parts.

### DESCRIPTION

It is to be understood that the figures and descriptions of the present invention have been simplified to illustrate elements that are relevant for a clear understanding of the present invention, while eliminating, for purposes of clarity, many other elements found in typical digital multimedia content delivery methods and systems. However, because such elements are well known in the art, a detailed discussion of such elements is not provided herein. The disclosure herein is directed to all such variations and modifications known to those skilled in the art.

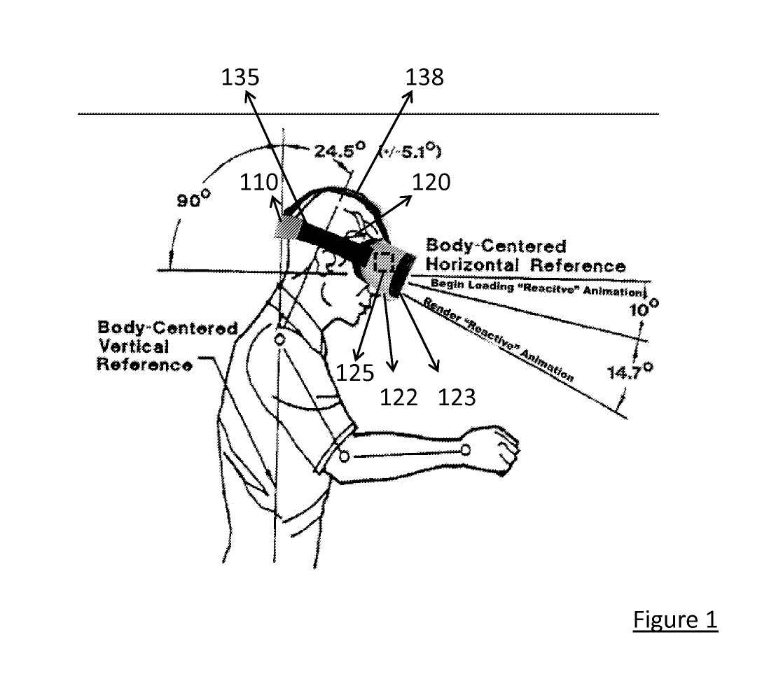

FIG. 1 shows an example of a virtual reality (VR) system (110) having reactive animation capability and features. In this embodiment, the VR system (110) is a head mounted optical system that has or is coupled to at least one processor or computer (125) (shown with broken dashed lines to indicate the placement may be inside or outside of a housing unit). The processor (125) may be configured to enter into processing communication with other processors and computers in a computing environment or network. In addition, the VR system (110) has access to or includes storage locations for storing of data. The system can be wired or wireless.

In one embodiment, such as the one shown in the figures, the VR system 110 comprises an optical system consisting of a housing (120). A variety of designs can be used as known to those skilled in the art. In the embodiment of FIG. 1, the housing includes adjustable straps (135) configured to extend radially around the periphery of a user's (also referenced as player) head. An additional strap (138) may be added, to help keep the housing (120) firmly in place and add to structural rigidity. In one embodiment, the straps (135) can be adjustable in length and include a fastener or they may be made out of elasticized material. In other embodiments, as can be appreciated by those skilled in the art, the straps may have additional components such as fasteners. The housing (120) can also alternatively made with less structure, for example one that allows it to be worn like sunglasses, or be made more rigorously like a mask that partially or entirely covers the head or face, or be designed somewhere in between depending on the rigor or application that is needed.

In one embodiment, the housing (110) is configured for coupling to a display which includes at least a viewing section (122) that covers the eyes. In one embodiment, the viewing section (122) has one lens that stretches over both eyes and enables viewing of at least one display. In another embodiment, as shown in FIG. 1, two lenses (123) are provided defining a visual plane such that a first lens is disposed between a first display and a first of the person's eyes and a second lens is disposed between the display and a second of the person's eyes. In another embodiment, a single unitary lens can be provided over both eyes. When a unitary viewing area and a single lens is provided, the lens will be disposed between the display and the person's eye. In one embodiment, the eyes can be each covered with a separate frame (123). In the embodiment depicted, the housing (110) is configured to be coupled to a single display but in alternate embodiments, two or more displays may be used, especially in a case where separate lenses are provided such that the left and the right eye lenses are coupled to left and right eye displays. In addition,

The display (not illustrated) can be provided in a variety of ways. In one embodiment, a receiving area is provided in the viewing section (120) to receive a mobile device such as a smart phone, having a display, a processor and other components. One example can be a wireless communication interface and one or more sensors (accelerometers) for sensing a movement, position, or attitude or a user's head or change or rate of change in any of the foregoing parameters

In one embodiment, a display and a processor can be coupled to the housing (120) and the viewing section (122) or they may be in processing communication to local or remote devices (gaming units, mobile tablets, cell phones, desktops, servers or other computing means coupled to them and be or. In one embodiment, the viewing section (122) may even include a receiving area (not illustrated) that is sufficiently large to receive a display connected to a smart phone or other devices as can be appreciated by those skilled in the art.

In another embodiment the VR system (110) is an optical system having a virtual reality head-mounted display comprising of a housing (120) configured for coupling with a display (not illustrated). The housing (120) defines a first and a second optical paths, respectively, for providing focus by first and second eyes of a user on a first and second portions of the display, respectively. As mentioned, a sensor may be provided that is operatively coupled with the housing and configured to detect a first change in a position of the housing from a first position to a second position, and detect a second change in a position of the housing defining a change greater than the first change, such that a processor coupled to the display is configured to render a first animation for output on the display, pre-load a second animation upon the sensor detecting a first change in position, and render the second animation for output to the display upon the sensor detecting the second change in position.

An illustrative example will be provided now to ease understanding. In FIG. 1, a user is standing in centered position with the horizontal and vertical axis are at equilibrium when the user is standing straight and looking forward. The user is wearing the head mounted VR system (110). Once a positional change occurs in form of a head tilt, the processor (125) will shift to an animation mode as will be also discussed in conjunction with FIG. 2. In this embodiment, the value for the angle deviation is set to 10 degrees. This means that a head tilt of between 0 and 10 degrees will be recognized as a change in position but the reactive animation mode will not be engaged until the preselected value (here 10 percent) is met or exceeded.

In this example, once the reactive animation is (loaded) engaged, a further head or body movement will then initiate additional reactive animation if the change again is greater than a particular value. In this example, this value is set to 14.7 degrees. After the value is exceeded, any further positional changes, starts the reactive animation phase and projects images on the display(s), such that the images being projected are responsive to the additional positional changes as will be discussed. In the Example shown in FIG. 1, the deviation value is reached at 10 and then 14.7 degrees as discussed, however, these valued are only used for exemplary purposes and other values can be selected. It should be noted that once the deviation value of 14.7 is exceeded and the reactive animation mode is fully engaged, all additional head tracking movements will initiate additional animations creating a feedback experience that is constantly activated and updating (through the head movement) as the line of sight touches other Graphical User Interface (GUI) elements in the User Interface (UI).

In one embodiment, a determination is made about the “line of sight” that applies to a user who is stationed while watching content (e.g. a first animation). It the line of sight increases by X degrees, a second animation is preloaded, and when the line of sight breaks Y degrees (X<Y) the animation is activated. For example, an illustrative case of a user who is playing a Game H can be used. Game H is a game of the honor genre that can be downloaded to a mobile device or being played through other means. The user/player starts and engages the Reactive Animation by a head tilt (X degrees). The user's head then is used almost as a UI from that point on such that the user choses certain actions just by a head tilt. In one embodiment, both voluntary or involuntary actions may be used. For example, as the player enters into this VR world, a variety of honor scenes and options are presented to him/her that he/she selects voluntarily. However, in one instance, user may see a particularly gruesome scene and the player involuntarily moves user's head in a particular direction causing other scenes to be displayed to him/her. In one embodiment, this involuntary action, may provide other preloaded images, for example, in a different area of an VR imaginary room where the user/player is located in the game. In one embodiment, the user/player can take advantage of available technology such systems like M-GO Advanced, Oculus Rift or Gear VR.

In one embodiment, the VR system may even capture the type of image and the instance where the user/player reacts strongly to the displayed content and use the knowledge later in the game or in other games to provide more specifically engineered experiences for that particular user.

Reactive animation can be provided by the processor (125) in a number of ways as known to those skilled in the art. For example, in one embodiment, this can be provided as a collection of data types and functions for composing richly interactive, multimedia animations that will be based mostly on the notions of behaviors and events. Behaviors are time-varying, reactive values, while events are sets of arbitrarily complex conditions, carrying possibly rich information. Most traditional values can be treated as behaviors, and when images are thus treated, they become animations.

In a different embodiment, also as illustrated in FIG. 1, the user is in an upright centered body position, and is engaged in viewing content on the VR system (110). In this embodiment, at any time the user lowers his/her line of vision below a central median, the apparatus begins a dynamic experience instead of one that is pre-loaded. This may mean that instead of having the stored in a previous location, the experience is dynamically created. This allows access to a dynamic real live experience which may involve use of cameras or other devices in the actual location that is now being projected live through the processor (125) being in communication with other devices, or networks such as the Cloud.

In another embodiment, the VR system 110 may include other components that can provide additional sensory stimulus. For example, while the visual component allows the user to experience gravity, velocity, accelerations, etc., the system 110 can provide other physical stimulus such as wind, moisture, smell that are connected to the visual component to enhance the user's visual experience.

In one embodiment of the invention, content provided to the user through the VR system 110 can also be presented in form of augmented reality. In recent years, augmented reality has been expanded to provide a unique and experience that can be used in a variety of fields including the entertainment field. Augmented reality, often uses sensory input create a real worked element through computer generated sensory input, such as through adaptive streaming over HTTP (also called multi-bitrate switching) is quickly becoming a major technology for multimedia content distribution. Among the HTTP adaptive streaming protocols which are already used, the most famous are the HTTP Live Streaming (HLS) from Apple, the Silverlight Smooth Streaming (SSS) from Microsoft, the Adobe Dynamic Streaming (ADS) from Adobe and the Dynamic Adaptive Streaming over HTTP (DASH) developed by 3GPP within the SA4 group. The technology for augmented reality is known to those skilled in the art and will not be further discussed.

FIG. 2 is an illustration of a flowchart describing one embodiment using a virtual reality experience to a user via a head-mounted display, such as discussed in the embodiment of FIG. 1. Step 210 is an initiation step where the deviation angles can be preselected and a baseline for line of sight is established. Step 220, detects, using the processor (125), a first change in the position of the user. If there has been a change and the change exceeds the preselected deviation value as shown in step 230, the reactive animation is engaged (step 240). If then there has been a second positional and a second value has exceeded, the reactive animation becomes fully engaged (step 250). In a separate embodiment, any horizontal and vertical change in vales can fully engage the system.

Once the reaction animation is fully engaged, any additional head movement will then provide corresponding scenes as shown in step 260 accordingly. In other words, as discussed, once in the reactive animation mode, all additional head tracking movements will initiate additional animations, creating a feedback experience that is constantly activated and updating as their line of sight touches other graphic user interface devices and components that can be viewed virtually through these other user interfaces.

While some embodiments has been described, it will be understood that those skilled in the art, both now and in the future, may make various improvements and enhancements which fall within the scope of the claims which follow. These claims should be construed to maintain the proper protection for the invention first described.

What is claimed is:

1. A system, comprising:
a housing for mounting on a user's head for coupling with a display, the housing permitting viewing focus on the display;
a sensor configured to detect a first change in a position of said housing from a first position to a second position, and detect a second change in a position of said housing greater than said first change;
a processor operatively coupled to said housing and said sensor and configured to render a first animation for output on said display upon said first change in position and a second animation from a plurality of animations for output to said display based on said sensor detecting said second change in position.

2. The system of claim 1, wherein the housing is a first housing further comprising the display.

3. The system of claim 2, wherein the display, the sensor, and the processor are integrated within a second housing coupled with said first housing.

4. The system of claim claim 3, wherein the first change in position defines a first angle from the first position, and the second change in position defines a second angle from the first position, wherein the second angle is greater than the first angle.

5. The system of claim 4, wherein the first angle exceeds 10 degrees.

6. The system of claim 5, wherein the second angle exceeds 14 degrees.

7. The system of claim 6, wherein said housing has a receptible for receiving a mobile device and said sensor is configured to detect said first and second change in position of said mobile device.

8. The system of claim 7, wherein said sensor is provided in said mobile device.

9. The system of claim 1, wherein said first and second environments are virtual reality environments.

10. The system of claim 9, wherein said first change in position defines a first angle from a first position, and the second change in position defines a second angle from said first position and wherein the second angle is greater than the first angle.

11. The system of claim 10, wherein selection of said second virtual reality environments is made amongst a plurality of virtual reality environments that are each different than said first virtual reality environment.

12. The system of claim 11, wherein selection of said second virtual reality environments amongst said plurality of other virtual reality environments is dependent on selection of said first virtual reality environment.

13. The system of claim 12, wherein selection of said second virtual reality environments depends on angle of change in said user's second position.

14. A method, comprising:
rendering an image for viewing by a user via a head mounted housing operatively coupled to a display and processor;
detecting via a sensor coupled to said processor a first change in a position of said housing from a first position to a second position, and detecting via said sensor a second change in a position of said housing greater than said first change;
rendering, via said processor, a first animation for output on said display upon said first change in position and rendering, via said processor, a second animation from a plurality of animations for output to said display based on said sensor detecting said second change in position.

15. The method of claim 14, wherein the display, the sensor, and the processor are integrated within a second housing coupled with said first housing.

16. The method of claim 15, wherein the first change in position defines a first angle from the first position, and the second change in position defines a second angle from the first position, wherein the second angle is greater than the first angle.

17. The method of claim 14, wherein the first angle exceeds 10 degrees and the second angle exceeds 14 degrees.

18. The method of claim 14, wherein said housing has a receptible for receiving a mobile device and said sensor is configured to detect said first and second change in position of said mobile device.

19. The method of claim 18, wherein said sensor is provided in said mobile device.

20. An apparatus, comprising:
a head mounted housing for receiving a mobile device; said mobile device having a first display and a sensor for sensing user change in head position;
a processor operatively coupled to said housing and said mobile phone and enabled to render two dimensional images into three dimensional images for outputting on a display;
said processor further enabled to render a first image from a first environment upon sensing a first change in a user's position via said sensor and render a second animation of a second different environment to said display based on a second subsequent change in user position.
